(19) United States
(12) Patent Application Publication
(10) Pub. No.: US 2009/0290284 A1
(43) Pub. Date: Nov. 26, 2009

(54) Electrical Component and External Contact of an Electrical Component

(76) Inventors: Andreas Gabler, Graz (AT); Volker Wischnat, Deutschlandsberg (AT)

Correspondence Address: SLATER & MATSIL, L.L.P., 17950 PRESTON RD, SUITE 1000, DALLAS, TX, 75252-5793, US

(21) Appl. No.: 12/488,155

(22) Filed: Jun. 19, 2009

Related U.S. Application Data
(63) Continuation of application No. PCT/DE2007/002261, filed on Dec. 17, 2007.

(30) Foreign Application Priority Data
Dec. 20, 2006 (DE) 10 2006 060 432.6

(51) Int. Cl. H01G 4/12; B32B 5/18; H01C 7/10

(52) U.S. Cl. 361/321.2; 428/613; 361/321.1; 338/21

(57) ABSTRACT

An electric component has a base body. A surface of the base body is provided with at least one first electrically conductive material layer and the first material layer is coated with a further electrically conductive material layer on the surface facing away from the base body. The material layers form at least part of an external contact that has a closed, porous, outer surface.

This application is a continuation of co-pending International Application No. PCT/DE2007/002261, filed Dec. 17, 2007, which designated the United States and was not published in English, and which claims priority to German Application No. 10 2006 060 432.6 filed Dec. 20, 2006, both of which applications are incorporated herein by reference.

### BACKGROUND

An electrical component and also an electrical external contact with such a component will be described.

### SUMMARY

In one aspect, the present invention specifies the ability of an electrical component to form an electrical contact that allows the formation of a stable electrical contact of the component with an electrical terminal.

An electrical component with a base body will be specified, wherein one surface of the base body, for example, a side face, is provided with at least one first electrically conductive material layer and the material layer is provided with another electrically conductive material layer on its surface facing away from the base body.

The first and the additional material layers together form at least one part of an external contact of the electrical component that has, accordingly, a closed, porous, external surface. The electrical component can have several such external contacts.

It is favorable if at least one part of the electrical component that should be provided with the material layer or with the external contact can be electroplated for producing a first material layer. The phrase “can be electroplated” is understood to be the ability of an object to form a coating or an external layer, in particular, a metallic deposit, by means of electrochemical or chemical deposition. It is preferred that at least the part of the component provided with the external contact be subjected to an electrolytic electroplating method.

The part of the electrical component that can be electroplated comprises, in particular, a fired material layer of the component.

The closed but porous surface of the external contact has the advantage that the component can be mounted on a mounting plate such that it is fixed or cannot be pulled off, or can be contacted to another electrical terminal, such as, for example, an electrical feed line.

The term “porous” is understood to be, in particular, the property of an external contact of the component, according to which the external contact has indentations whose depths advantageously lie in the range of micrometers.

A porous surface of an external contact of the electrical component increases its electrically conductive contact surface area and this reduces the resistance in the boundary region between an external electrical terminal and the component. An increase in the surface of the external contact is also to be viewed as increased surface roughness of the external contact. The component is advantageously a conductive adhesive, surface mountable (SMD) component that is especially suitable for forming a contact with a mounting plate.

Several electrical, optionally counter poled, external contacts of the described type could be provided that are each formed on one side face of the component. In this way, the first or inner electrically conductive material layer of the external contact could partially or completely cover not only one side face; it could also encompass the component at the sides like a kind of cap or clamp, so that, for example, the top and bottom end faces of the component are provided with a region of the external contact.

According to one embodiment of the electrical component, the first electrically conductive material layer is fired into the base body. It is preferably produced by applying a metal-containing paste on the base body of the component, wherein this paste is fixed by firing. This has the advantage that the surface of the first material layer is porous and kept as large as possible.

It is preferred that the additional material layer be configured as thin as possible or with the smallest possible thickness. This has the advantage of simultaneously keeping the surface of the additional material layer or that of the external contact having the first and the additional material layer as large as possible, because the additional material layer is formed directly on the first. According to one embodiment of the electrical component, one or each thickness of the first material layer lies in the range from 0.5 to 5 μm.

According to one embodiment, the additional material layer is formed on the first material layer using an electroplating method.

The material layers can each contain a metal. It has proven especially favorable if the first or the inner material layer of the outer contact has a solid material that can be electroplated, such as, for example, copper, and the additional or outer material layer contains a conductive adhesive material. Here it is preferred that the outer material layer contain a palladium-containing alloy, in particular, a nickel-palladium alloy. The palladium-containing alloy has the advantage that it can be adhered especially well with a circuit board and also has the property of protecting the inner material layer from oxidation.

An outer material layer containing a nickel-palladium alloy advantageously has higher ductility relative to a pure palladium layer or a palladium-electroplated layer. Additional advantages of an outer material layer containing a nickel-palladium alloy are shown below, for example, in comparison to a fired silver-palladium layer:
a base body can be used directly from a standard fabrication method,
no additional metallization steps and also no additional firing processes are required,
the outer material layer is very thin, so that an already existing, inner surface structure remains essentially unchanged,
material savings are achieved relative to other techniques for the deposition of metal-containing layers,
the outer layer can be formed on all components that can be electroplated,
complex outer electrode geometries can be easily processed.

The base body of the electrical component at least partially encompasses any electronic component that can be electroplated. The base body can have a capacitance, a resistance, such as, for example, a varistor, or other electrically poor conducting properties. For example, it could contain a ceramic material, such as a capacitor ceramic or a varistor ceramic.

Advantageously, using an external contact comprising an outer electroplated layer, components with different, especially complex, external contacts could be easily fabricated. These components would otherwise require, first, the development and then execution of more complicated processes comprising both metallization and also firing.

According to one embodiment of the electrical component, external contacts of the component have a multilayer structure, wherein these external contacts can contact an external electrical terminal or a circuit board. In this embodiment, at least one first material layer made from a first production type, for example, from a firing process, and at least an additional material layer of a second production type, for example, from an electroplating process, form at least one part of the structure.

One embodiment of the electrical component comprises an electrical multilayer component whose base body comprises several ceramic layers and electrode layers stacked one above the other in an alternating pattern. Here, electrode layers could be led up to the surface of the base body and each could be contacted at one end to an external contact of the described type.

The electrode layers could be constructed as internal electrodes that are used to establish an electric field, especially in connection with an electrically insulating material, a capacitance within each ceramic layer lying between two adjacent internal electrodes.

The ceramic layers of an electrical multilayer component could here contain a capacitor ceramic with which an SMD-capable multilayer ceramic capacitor, also called MLCC, is created using a suitable internal electrode material, for example, copper. This could be used, for example, in an electronic filter, for example, for processing electrical signals. In particular, the ceramic multilayer capacitor could be used in a mobile communications device, wherein the fixed electrical and mechanical bonding of the electrical multilayer component has the advantage, due to its two-layer external contact with a large contact surface area, that the electrical multilayer component does not detach from a circuit board or from another electrical terminal due to vibrations or jolts.

The ceramic layers of the electrical multilayer component according to one embodiment contain a varistor ceramic with which an SMD-capable ceramic multilayer varistor is specified using a suitable internal electrode material, for example, copper. This could be used as a device for the overvoltage protection of an electronic device.

One or more external contacts according to at least one embodiment described in this document are not limited to capacitors or varistors. An external contact of the described type could be used, instead, for all types of electrical components. These shall include, for example, NTC components, PTC components, and also any type of monolithically structured electrical components and could contain electrical component arrays that are fabricated in one piece or that have a base body and optionally several different materials, in particular, resistance materials. An external contact of the described type can also be used for forming a contact with piezoelectric actuators or piezoelectric stacks, in particular, internal electrodes arranged between piezoceramic layers.

Ceramic layers of an electrical multilayer component are produced advantageously from ceramic green films that could be provided with a binder, cut to size, and then sintered together, in order to obtain a monolithic multilayer component. The ceramic green films could be provided with printed electrode structures or materials, for example, by means of a screen-printing method.

### BRIEF DESCRIPTION OF THE DRAWINGS

The described subject matter will be explained in greater detail with reference to the following embodiments and figures. Shown here are:

FIG. 1 shows an electrical, multilayer component with a multilayer external contact;

FIG. 2 provides an enlarged diagram of a part of an electrical multilayer component with a multilayer external contact;

FIG. 3a shows a first electrical component as an array with multilayer external contacts;

FIG. 3b shows a first electrical component as a feedthrough array with multilayer external contacts;

FIG. 3c shows another electrical component as a feedthrough array with multilayer external contacts;

FIG. 3d shows an electrical component with a ball grid array with hemispherical, two-layer external contacts;

FIG. 4a shows a circuit diagram of a first possible electrical circuit of the component shown schematically in FIG. 4a; and

FIG. 4b shows a circuit diagram of a second possible circuit of the component shown schematically in FIG. 4a.

The following list of reference symbols can be used in conjunction with the drawings.
1 Electrical component
2 Ceramic base body
2a Ceramic layers
3 Inner layer of an external contact
4 Outer layer of an external contact
5 Electrode layers
6 External contact
6′ Additional external contact
A First external contact
B Second external contact
C Third external contact opposite the first external contact
D Fourth external contact opposite the second external contact
K Capacitance

### DETAILED DESCRIPTION OF ILLUSTRATIVE EMBODIMENTS

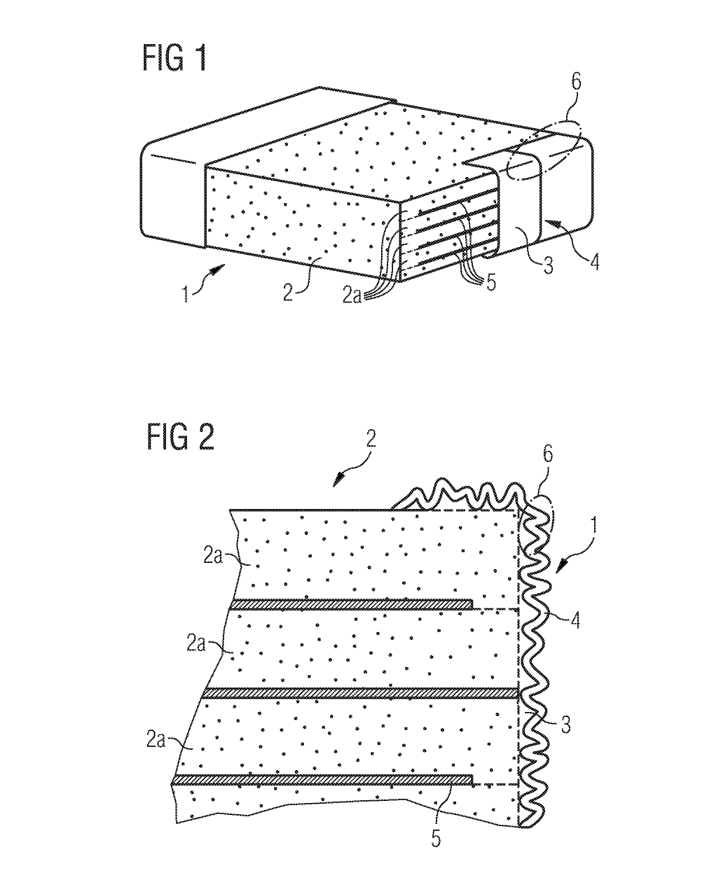

FIG. 1 shows an electrical multilayer component 1 with a monolithic, sintered base body 2 that contains a ceramic material, for example, a capacitor ceramic or a varistor ceramic. The base body comprises a stacked arrangement of ceramic layers 2a and also internal electrodes 5. For a set of electrically equal poled internal electrodes 5, the end of each internal electrode is led up to the surface of the base body 2 and forms a contact with a fired electrode layer 3 that contains, for example, copper. The electrode layer 3 forms a first inner layer of an external contact 6 of the multilayer component. Another metal-containing or noble metal-containing layer, advantageously a Pd—Ni (nickel-palladium) alloy layer 4 is electroplated on the outside on the surface of the inner electrode layer 3 facing away from the base body 2.

The external contact 6 formed from the inner layer 3 and the outer layer 4 embraces one side of the multilayer component like a cap.

On the opposite side of the multilayer component is formed another, counter poled external contact 6 that forms a contact with the ends of equal poled internal electrodes 5 of a different internal electrode set. According to one embodiment, an additional external contact could also be constructed according to a two-layer external contact of the described type.

FIG. 2 is an enlarged diagram of a corner region of an electrical component 1 that is shown, for example, as a multilayer component. It is shown how the first and inner layer of an external contact 6, wherein this inner layer is formed on the surface of a base body 2, is fired into the surface region of the base body and has an irregular surface structure that is closed and porous. Another layer 4 is formed on this inner layer 3, wherein this additional layer now forms the outer surface of the external contact. It is constructed as thin as possible, so that an external contact with a surface area corresponding to that of the underlying layer can be achieved as much as possible. Here, the outer layer 4 is advantageously electroplated onto the inner layer.

Although the figures show multilayer components, external contacts of the described type could be formed on any electrical component with porous base bodies and/or on any electrical component with material regions or layers that could be electroplated.

More than two material layers could be provided for each external contact, wherein it is then important that the outer surface of the electrical component nevertheless have a sufficiently large surface area for tight bonding with a mounting surface. The material layers could here contain materials according to preferred properties. They could be, but are not required to be, deposited onto each inner material layer using electroplating.

Also, external contacts of the described type could be deposited on each side surface of an electrical component. On each surface, several external contacts of the described type could also be deposited.

A block-shaped base body could be provided with four or more external contacts. Thus, the electrical component could selectively form, with one of its external faces, contacts to a mounting surface or another electrical terminal. Here, each external contact could form a contact with an electrode layer that carries the same electrical pole as the external contact. Ground-electrode layers are here similarly applicable as electrode layers.

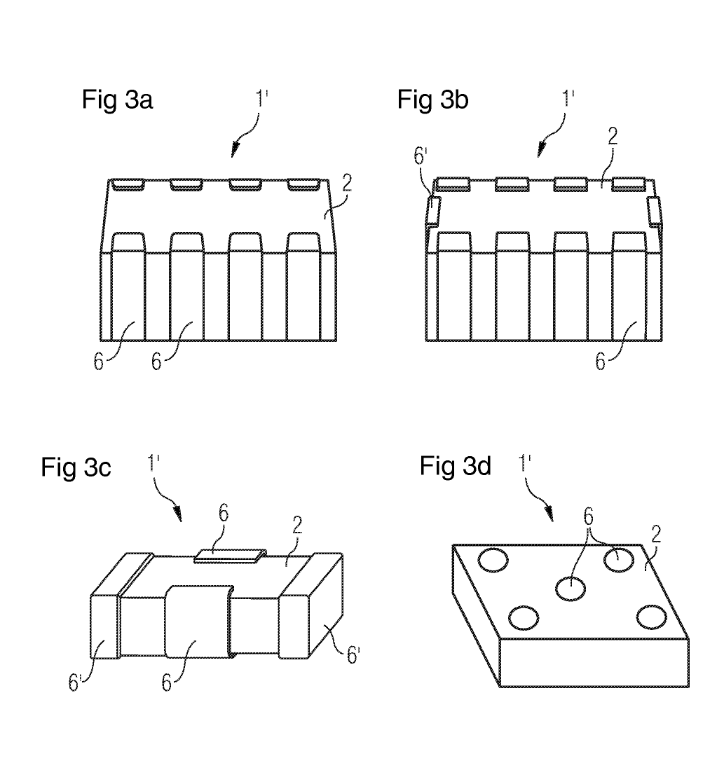

FIGS. 3a to 3d show different electrical components that are provided with one or several external contacts 6 each including an inner fired layer 3 and an outer layer 4 advantageously electroplated onto the inner layer 3.

FIG. 3a shows an advantageously one-piece electrical component 1′ that is constructed as an array. On the longer side faces of a block-shaped base body 2, external contacts 6 arranged one next to the other are shown that each comprise an inner, fired, metallic layer and an outer, electroplated, second metallic layer. A stack of internal electrodes of different electrical polarity arranged one above the other in an alternating pattern could be arranged between every two opposing external contacts 6. Capacitors could be generated between these internal electrodes. The base body could contain a resistance material or an electrically insulating material, such as, for example, ceramic, wherein this material is arranged between the internal electrodes.

According to one embodiment, the electrical component is a ceramic multilayer component array in which several multilayer components are arranged one next to the other in one component.

FIG. 3b shows an advantageously one-piece electrical component 1′ that is constructed as a feedthrough array. On four side faces of a block-shaped base body 2, external contacts 6 and 6′ arranged one next to the other are shown, wherein each contact comprises an inner, fired, metallic layer and also an outer, electroplated, second metallic layer. A feedthrough, for example, a resistor or a ground electrode, could connect the two opposing external contacts 6′ arranged on the end faces of the block-shaped base body. A stack of internal electrodes of different electrical polarity arranged one above the other in an alternating pattern could be arranged between every two opposing external contacts 6.

FIG. 3c shows another electrical component 1′ that is provided with opposing external contacts 6′ and 6 of the described composition(s). In this example, the external contacts 6, 6′ form, overall, four large surface-area contacting surfaces with good fixing properties for contacting external electrical terminals. An advantageously exposed base body face 2 is shown between the external contacts. If necessary, this could also be passivated according to the corresponding embodiment of the electrical component with multilayer external contacts. The passivation could be formed, for example, before the fabrication of the external contacts on the base body 2.

FIG. 3d shows an electrical component 1′ constructed on one of its external faces that faces an external contact or that is to form a contact with an external contact with partially ball-shaped external contacts 6 as a so-called ball grid array. The external contacts have a multilayer structure according to the described type and are therefore used for good fixing or forming of an electrical contact with an external electrical contact, such as, for example, a circuit board or one or more feed lines or track conductors.

A base body 2 of each electrical component described here could contain materials other than ceramic; what is important is that the external contacts 6 for the component feature good adhesive or soldering properties.

For the described electrical components, advantageously only the regions of the external contacts 6, 6′ that are facing an external electrical terminal, such as, for example, a mounting surface, a circuit board, or an external terminal, such as, for example, a feed line, or that are contacted/soldered to it have a multilayer construction, that is, a construction with a fired layer and an electroplated layer. These regions of the external contacts 6, 6′ have a largest possible surface area, in order to allow good fixing with the external electrical terminal.

From production-specific viewpoints, it could be favorable if the entire component is immersed in an electroplating bath and the already fired regions or parts of the external contacts are electroplated in these regions, so that the external contacts are provided with an electroplated layer across their entire external surface.

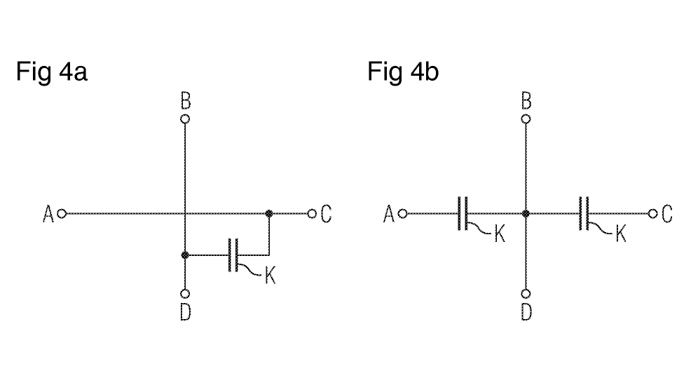

FIGS. 4a and 4b show circuit options of an electrical component with multilayer external contacts described according to this document.

FIG. 4a shows a circuit diagram of a possible first electrical circuit of an electrical component described with reference to this document, for example, a capacitor that can be surface mounted, wherein opposing, equal poled external contacts A and C of the component are electrically connected to each other on one side and opposing, equal poled external contacts B and D of the component are electrically connected to each other on the other side and between these contacts there is a capacitance K or a capacitor. This could be realized, for example, such that an electrically conductive track or an internal electrode connects opposing external contacts A and C to each other, and another electrically conductive track or internal electrode connects other opposing external contacts B and D to each other. A dielectric between these conductive tracks, advantageously in the form of a dielectric layer, then generates the mentioned capacitance K. In this way, a so-called feedthrough capacitor is created.

FIG. 4b shows a circuit diagram of a possible first electrical circuit of an electrical component described with reference to this document, for example, a capacitor that can be surface mounted, wherein opposing, equal poled external contacts A and C of the component are connected to an internal electrode or to a stack of internal electrodes, and internal electrodes connected to different external contacts are separated from each other by means of a dielectric gap. A continuous electrically conductive track or internal electrode could run between the external contacts B and D and could connect these contacts to each other electrically. With reference to the electrically conductive track between the different opposing external contacts B D of the component, the capacitance generated by the gap and the adjacent electrically charged surfaces forms a capacitance pair or a so-called matched pair capacitance arrangement or a so-called common ground capacitor, if it is a ground line that connects the external contacts B and D to each other.

What is claimed is:

1. An electrical component comprising:
a base body;
a first electrically conductive material layer at a surface of the base body;
a second electrically conductive material layer coating a surface of the first material layer, the surface facing away from the base body, wherein the first and second material layers form at least part of an external contact that has a closed, porous, external surface.

2. The electrical component according to claim 1, wherein the first material layer is fired into the base body.

3. The electrical component according to claim 1, wherein the first material layer comprises a material that can be electroplated.

4. The electrical component according to claim 1, wherein the first material layer comprises copper.

5. The electrical component according to claim 3, wherein the second material layer is formed on the first material layer by means of electroplating.

6. The electrical component according to claim 1, wherein the porosity of the external contact is given by the shape of the first material layer.

7. The electrical component according to claim 1, wherein the second material layer comprises a material with conductive adhesive properties.

8. The electrical component according to claim 1, wherein the second material layer comprises a material that protects the first material layer from oxidation.

9. The electrical component according to claim 8, wherein the second material layer comprises a noble metal.

10. The electrical component according to claim 1, wherein the second material layer comprises a nickel-containing alloy.

11. The electrical component according to claim 10, wherein the second material layer comprises a nickel-noble metal alloy.

12. The electrical component according to claim 11, wherein the second material layer comprises a Pd—Ni alloy.

13. The electrical component according to claim 1, wherein the electrical component is a surface-mountable component.

14. The electrical component according to claim 1, wherein the base body comprises a capacitor ceramic.

15. The electrical component according to claim 1, wherein the base body comprises a varistor ceramic.

16. The electrical component according to claim 1, wherein the base body comprises a plurality of ceramic layers and electrode layers stacked one above the other, whereby the electrical component is an electrical multilayer component.

17. The electrical component according to claim 16, wherein the electrode layers comprise nickel, copper, and/or palladium.

18. The electrical component according to claim 16, wherein the electrical component is a monolithic component produced through sintering.

19. The electrical component according to claim 16, further comprising a plurality of additional external contacts, each external contact having an inner layer that contacts an end of a respective electrode layers.
